(19) United States
(12) Patent Application Publication
(10) Pub. No.: US 2019/0094666 A1
(43) Pub. Date: Mar. 28, 2019

(54) LIQUID CRYSTAL DRIVING APPARATUS AND IMAGE DISPLAY APPARATUS

(71) Applicant: CANON KABUSHIKI KAISHA, Tokyo (JP)

(72) Inventor: Teppei Kurosawa, Utsunomiya-shi (JP)

(21) Appl. No.: 16/135,302

(22) Filed: Sep. 19, 2018

(30) Foreign Application Priority Data
Sep. 27, 2017 (JP) 2017-186022

(51) Int. Cl. G03B 21/00; G09G 3/36; G09G 3/20

(52) U.S. Cl. CPC G03B 21/006; G09G 2340/16; G09G 3/2022; G09G 3/3648

(57) ABSTRACT

A liquid crystal driving apparatus configured to drive a liquid crystal display element includes a processor configured to generate a display image signal from an input image signal, and a driver configured to display, according to the display image signal, a tone to a pixel in the liquid crystal display element by controlling a voltage applied to the pixel in each of a plurality of subframe periods contained in one frame period between a first voltage and a second voltage lower than the first voltage. The processor performs a smoothing process for smoothing a tonal difference equal to or smaller than 3% of a full scale value of the tone in a target image area in the input image signal.

### BACKGROUND OF THE INVENTION

### Field of the Invention

The present invention relates to a liquid crystal driving apparatus that drives a liquid crystal display element by a digital driving method (pulse width modulation (PWM) method) in an image display apparatus, such as a projector or a direct view type display.

### Description of the Related Art

A pulse width modulation method is one liquid crystal driving method that expresses the tone (or gradation) by dividing one frame period into a plurality of subframe periods, and by controlling an application (ON) period and a non-application (OFF) period of the predetermined voltage to liquid crystal pixels in each subframe period. For example, in expressing 8-bit (256) tones, as illustrated in FIG. 14, one frame period is divided into eight subfield periods having different time widths (time width proportional to 2ⁱ where i=0 to 7). In each subfield period, whether the liquid crystal pixel is turned ON (white display state) or OFF (black display state) is controlled according to the tone to be displayed. This weighted subfield driving can change the total time in which white is displayed in one frame period into 256 stages (or patterns), and enables 256 tones to be expressed.

In the meanwhile, the pulse width modulation method when used to drive a micro display type liquid crystal display element would cause a dark line caused by a disorder of a liquid crystal orientation called a disclination and lower the image quality. For example, a pseudo contour 21 may occur due to the disclination in a gradation or tone area in which the tone smoothly changes like a blue sky in a landscape image illustrated in FIG. 15.

In an area 22 including the pseudo contour 21, for example, a liquid crystal pixel having a 127th tone and a liquid crystal pixel having a 128th are adjacent to each other and receive the weighted subfield driving with the pulse width modulation patterns as illustrated in FIGS. 16A and 16B. As described above, when the liquid crystal pixel in the a white display state 31 and the liquid crystal pixel in a black display state 32 are adjacent to each other for a long time, a dark line appears due to the disclination as illustrated in FIGS. 17A and 17B in one pixel and forms this pseudo contour in the image.

Japanese Patent Laid-Open No. (“JP”) 10-319905 discloses a method of superimposing a checker-shaped fine level offset pattern on an input image in order to reduce the image quality degradation caused by the pseudo contour that appears in displaying a motion image.

However, the method disclosed in JP 10-319905 does not intend to reduce the image quality degradation caused by the pseudo contour that appears due to the disclination. In addition, the method disclosed in JP 10-319905 when applied to the gradation area illustrated in FIG. 15 might make worse the image quality degradation caused by the disclination.

### SUMMARY OF THE INVENTION

The present invention provides a liquid crystal driving apparatus that can reduce the image quality degradation caused by the disclination, and an image display apparatus using the same.

A liquid crystal driving apparatus according to the present invention is configured to drive a liquid crystal display element. The liquid crystal driving apparatus includes a processor configured to generate a display image signal from an input image signal, and a driver configured to display, according to the display image signal, a tone to a pixel in the liquid crystal display element by controlling a voltage applied to the pixel in each of a plurality of subframe periods contained in one frame period between a first voltage and a second voltage lower than the first voltage. The processor performs a smoothing process for smoothing a tonal difference equal to or smaller than 3% of a full scale value of the tone in a target image area in the input image signal.

Further features of the present invention will become apparent from the following description of exemplary embodiments with reference to the attached drawings.

### BRIEF DESCRIPTION OF THE DRAWINGS

FIG. 1 illustrates an illustrative usage of a liquid crystal projector according to a first embodiment of the present invention.

FIG. 2 is a block diagram illustrating a configuration in the liquid crystal projector according to the first embodiment.

FIG. 3 illustrates a configuration of an image processor in the first and second embodiments.

FIG. 4 is a flowchart illustrating a noise filtering process according to the first embodiment.

FIGS. 5A and 5B illustrate effects of the noise filtering process according to the first embodiment.

FIG. 6 is a flowchart illustrating a noise filtering process according to the second embodiment of the present invention.

FIGS. 7A and 7B illustrate an epsilon filter.

FIG. 8 is a block diagram illustrating a configuration of an image processor according to a third embodiment of the present invention.

FIG. 9 is a flowchart illustrating a noise filtering process and a tone offsetting process according to the third embodiment.

FIGS. 10A and 10B illustrate effects of the tone offsetting process according to the third embodiment.

FIG. 11 illustrates a diffusion of a pseudo contour by signal processing according to the third embodiment.

FIG. 12 is a flowchart illustrating a noise filtering process according to the fourth embodiment of the present invention.

FIGS. 13A and 13B illustrate the effect of a noise filtering process according to the fourth embodiment.

FIG. 14 illustrates a pulse width modulation method.

FIG. 15 illustrates an illustrative pseudo contour.

FIGS. 16A and 16B illustrate weighted subfield driving for a liquid crystal pixel when the pseudo contour occurs.

FIGS. 17A and 17B illustrate an illustrative disclination.

FIG. 18 illustrates PWM driving of the liquid crystal display element in each embodiment.

### DESCRIPTION OF THE EMBODIMENTS

Referring now to the accompanying drawings, a description will be given of embodiments according to the present invention. In suppressing the image quality from degrading due to the pseudo contour derived from the disclination, the conventional method causes another image quality degradation such as lowering the brightness in an image, increasing a black level, or lowering the sharpness. On the other hand, a method according to each embodiment of the present invention suppresses the image quality from degrading due to the pseudo contour derived from the disclination without causing a new image quality degradation.

### First Embodiment

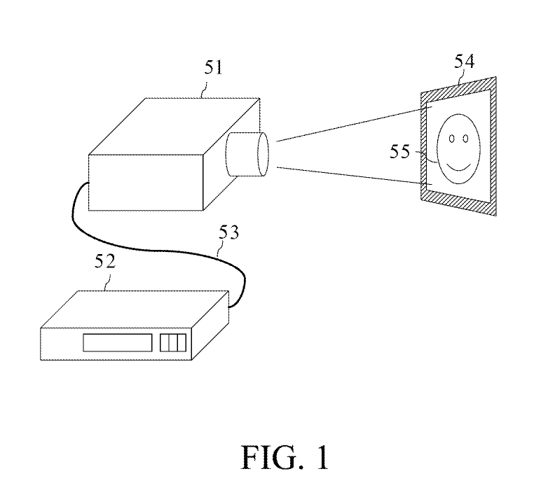

FIG. 1 illustrates an illustrative usage of a liquid crystal projector 51 as an image display apparatus according to a first embodiment of the present invention. An image signal output from a video player 52 as an image supply apparatus is input through a video cable 53 to the liquid crystal projector 51. The liquid crystal projector 51 modulates light from an unillustrated light source based on an input image signal and projects the resultant light onto a projection surface 54 such as a screen. A projection image 55 is displayed and viewed by the user.

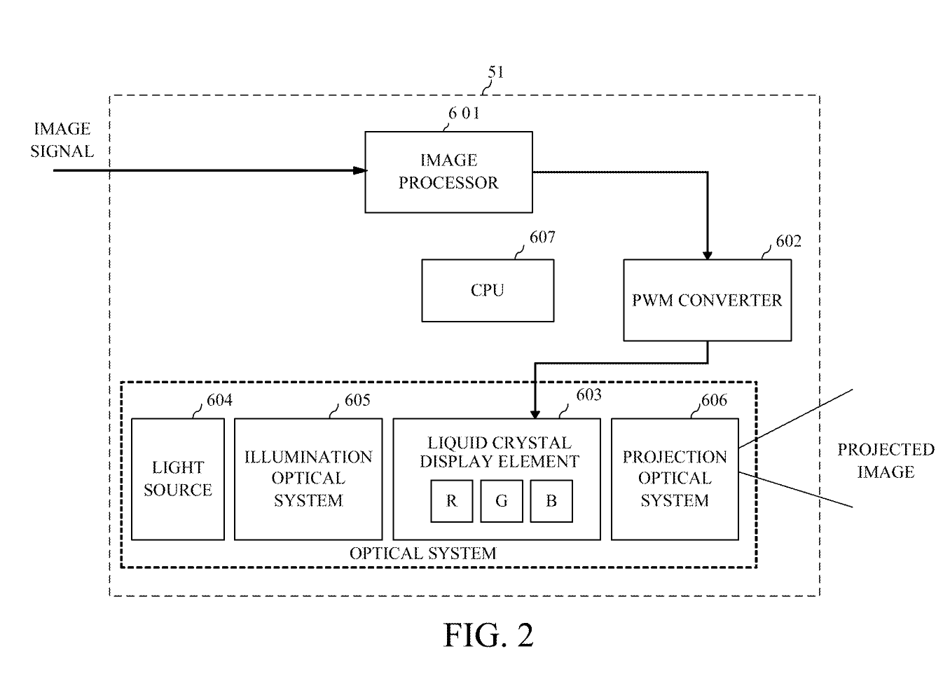

FIG. 2 illustrates the configuration in the liquid crystal projector 51. An image processor 601 as a processing unit performs a noise filtering process as a smoothing process for the image signal input to the liquid crystal projector 51. The image processor 601 performs other image processing, such as a brightness correction, a contrast correction, a gamma conversion, and a color conversion, for the noise-filtered image signal and generates a display image signal.

The display image signal output from the image processor 601 is input to a PWM converter 602 as a driver. The PWM converter 602 generates a pulse width modulation pattern of each liquid crystal pixel in a liquid crystal display element 603 according to tone (or gradation) information of the display image signal, and outputs it to a liquid crystal display element 603.

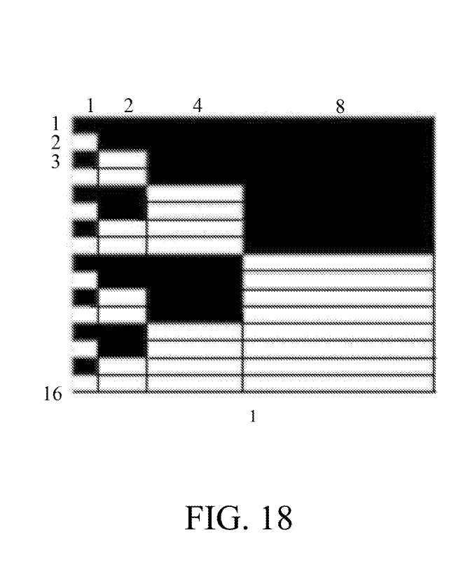

The pulse width modulation pattern indicates a combination of ON and OFF for each subfield when the weighted subfield driving of each liquid crystal pixel is performed. More specifically, as illustrated in FIG. 18, the PWM converter 602 divides one frame period in which the liquid crystal display element 603 displays one frame image into a plurality of subframe periods. Then, an ON/OFF pattern (PWM driving pattern) of the voltage application to the liquid crystal pixel in each of the plurality of subframe periods is generated according to the tone to be expressed, and the voltage application to the liquid crystal pixel is controlled according to the ON/OFF pattern. A first voltage as a predetermined voltage is applied to the liquid crystal display element 603 in the ON period in the ON/OFF pattern, and a second voltage lower than the first voltage is applied to the liquid crystal display element 603 in the OFF period. This configuration provides the weighted subfield driving as the digital drive (PWM drive) to the liquid crystal display element 603. The image processor 601 and the PWM converter 602 constitute a liquid crystal driver.

Each liquid crystal display element 603 modulates the light that is emitted from a light source 604 and passes through an illumination optical system 605 by the weighted subfield driving in accordance with the pulse width modulation pattern.

The illumination optical system 605 converts divergent light from the light source 604 into parallel light and converts it into polarized light having a predetermined polarization direction. The light modulated by the liquid crystal display element 603 is projected onto a projection surface, such as a screen, through a projection optical system 606. One liquid crystal display element 603 is provided for each of red (R), green (G), and blue (B). The liquid crystal display elements 603 for R, G, and B receive the R light beam, G light beam, and B light beam separated by an unillustrated color separation optical system after these light beams pass through the illumination optical system 605.

A CPU 607 as a computer controls the image processor 601, the PWM converter 602, and the light source 604.

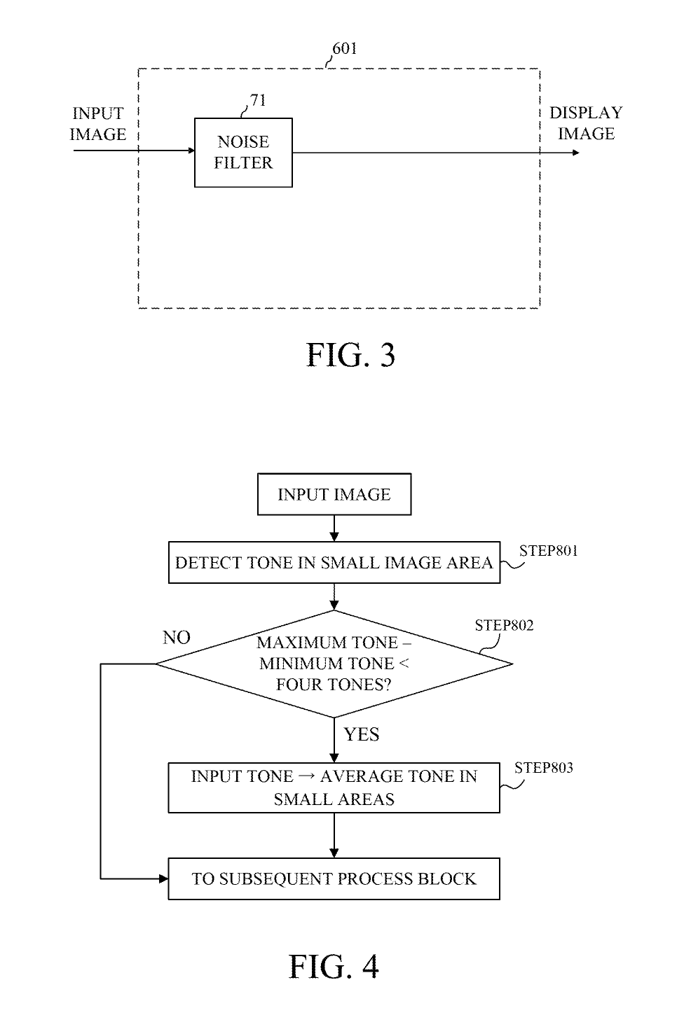

FIG. 3 illustrates a noise filtering process block 71 provided in the image processor 601. The image processor 601 further includes another processing block for other image processing subsequent to the noise filtering process block 71, but FIG. 3 illustrates only the noise filtering process block 71. Although this embodiment discusses the noise filtering process block 71 comprised of a signal processing IC as hardware, the noise filtering process block may be comprised of software.

Referring now to a flowchart in FIG. 4, a description will be given of the noise filtering process as the smoothing process performed by the noise filtering process block 71. Now assume that the input image signal expresses an 8-bit (256-tone) image. This is true of the following other embodiments.

In the step 801, the noise filtering process block 71 divides the 8-bit image expressed by the input image signal into a plurality of small image areas each being a rectangular region of 4 vertical pixels×4 horizontal pixels. The noise filtering process block 71 detects the maximum tone and the minimum tone among the tones of the 16 pixels in each small image area (within a target image area).

Next, in the step 802, the noise filtering process block 71 determines whether or not a difference between the detected maximum tone and the minimum tone is equal to or smaller than a predetermined value. The predetermined value, as used herein, is, for example, 4 tones in the 8-bit image (1.6% of the full scale value of the tone of an 8-bit image). If the difference is equal to or smaller than 4 tones, the small image area can be regarded as a flat image area including a small, less important or insignificant noise component. In other words, in this step, the noise filtering process block 71 determines whether or not each small image area is the flat image area.

The size and shape of the small image area and the predetermined value are not limited to those described above and may be changed. If the difference between the maximum tone and the minimum tone is smaller than the predetermined value when the predetermined value is 3% of the full scale value of the tone (or 7 tones for the 8-bit image), the small image area can be roughly regarded as a flat image area that contains the above noise component. In order to more reliably determine that the image area is a flat image area containing the noise component, the predetermined value may be set to 2% (5 tones for the 8-bit image) of the full scale value of the tone.

3% and 2% of the 10-bit (1024-tone) image correspond to 30 tones and 20 tones, respectively, and 3% and 2% of the 12-bit (4096-tone) image correspond to 122 tones and 81 tones.

In general, when the difference between the maximum tone and the minimum tone is 5% or more of the full scale value of the tone, the small image area is regarded as an unflat image area having a significant tonal difference. On the other hand, this embodiment determines whether or not the small image area is a flat image area having only a tonal difference corresponding to an insignificant noise.

The noise filtering process block 71, after determining that any of the small image areas is a flat image area in the step 802, calculates an average tone of the small image areas in the step 803. The tones of all the pixels in the small image area are replaced with the calculated average tone, and the average tone is output to the subsequent processing block. On the other hand, the noise filtering process block 71 when determining that the small image area is not a flat image area outputs the tone as it is to the other subsequent processing blocks without calculating the average tone of the small image areas.

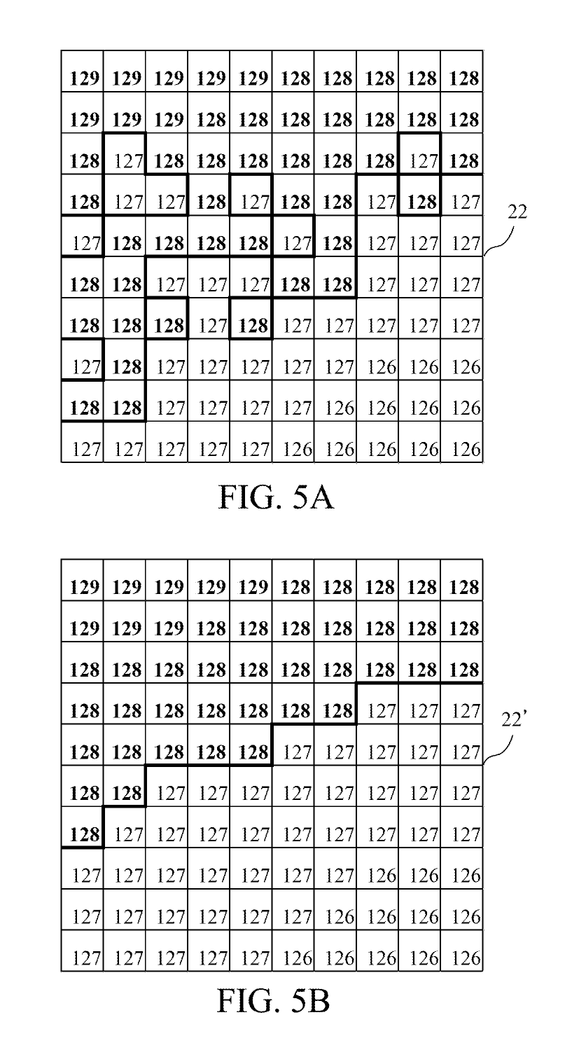

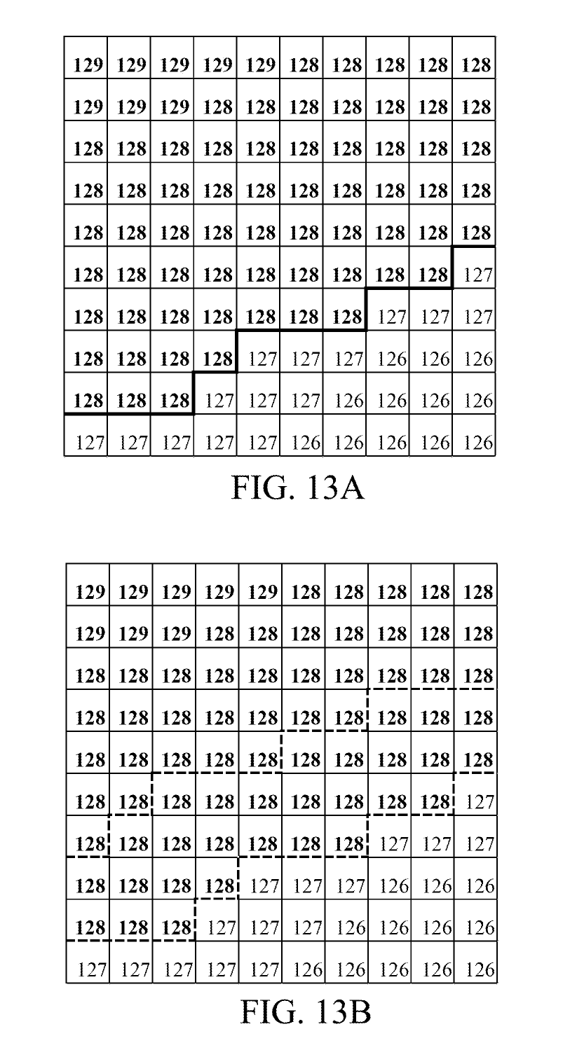

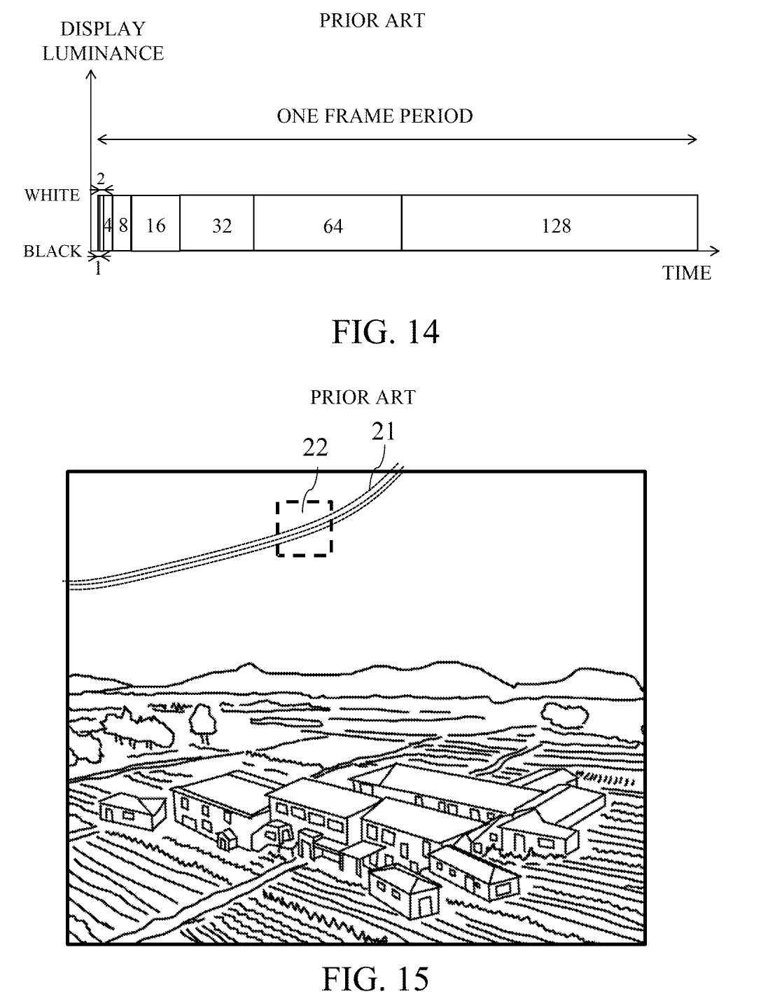

Next follows a description of the reason why the above noise filtering process can reduce the pseudo contour caused by the disclination. FIG. 5A illustrates a tone analysis result of an area 22 with the pseudo contour illustrated in FIGS. 13A and 13B in the input image signal. The area 22 is a gradational image area in which the tone gently increases from the bottom to the top, but a small amplitude of about 1 to 2 tones or a noise component with a high spatial frequency is added to the original change of this tone. As a result, the liquid crystal pixel having the 127th tone and the liquid crystal pixel having the 128th tone are irregularly adjacent to each other in a band-shaped range extending from the lower left to the upper right, and the dark line caused by the disclination that occurs in one of these liquid crystal pixels in the entire image illustrated in 15 appears as a belt-shaped pseudo contour.

On the other hand, FIG. 5B illustrates an analysis result of an area 22′ corresponding to the area 22 illustrated in FIG. 5A in the image signal that has received the noise filtering process is performed according to this embodiment. The noise component in the area 22 is reduced in this area 22′ and the liquid crystal pixel having the 127th tone and the liquid crystal pixel having the 128th tone are adjacent to each other on a line that extends from the lower left to the upper right in accordance with the original gradational tone change. The number of liquid crystal pixels causing the disclination in FIG. 5B is smaller than that in FIG. 5A. As a result, the dark line caused by the disclination appears to be a linear pseudo contour in the entire image. Since the linear pseudo contour is less conspicuous than the band-shaped pseudo contour, the image quality can be improved.

A conventional noise filter intends to remove the noise component generally recognized as the image quality degradation, such as roughness and flicker, and causes a side effect, such as the reduced MTF in the image signal. On the other hand, this embodiment intends to remove only a small noise component at a level lower than the level recognized as a noise component, and can restrain the image quality caused by the disclination from degrading while the MTF in the image signal is little influenced.

This embodiment discusses the noise filtering process performed for the small image area in which the disclination occurs and the liquid crystal pixel having the 127th tone and the liquid crystal pixel having the 128th tone are adjacent to each other. However, the noise filtering process may be performed for a small image area where the disclination occurs and the liquid crystal pixels having other tones are adjacent to each other.

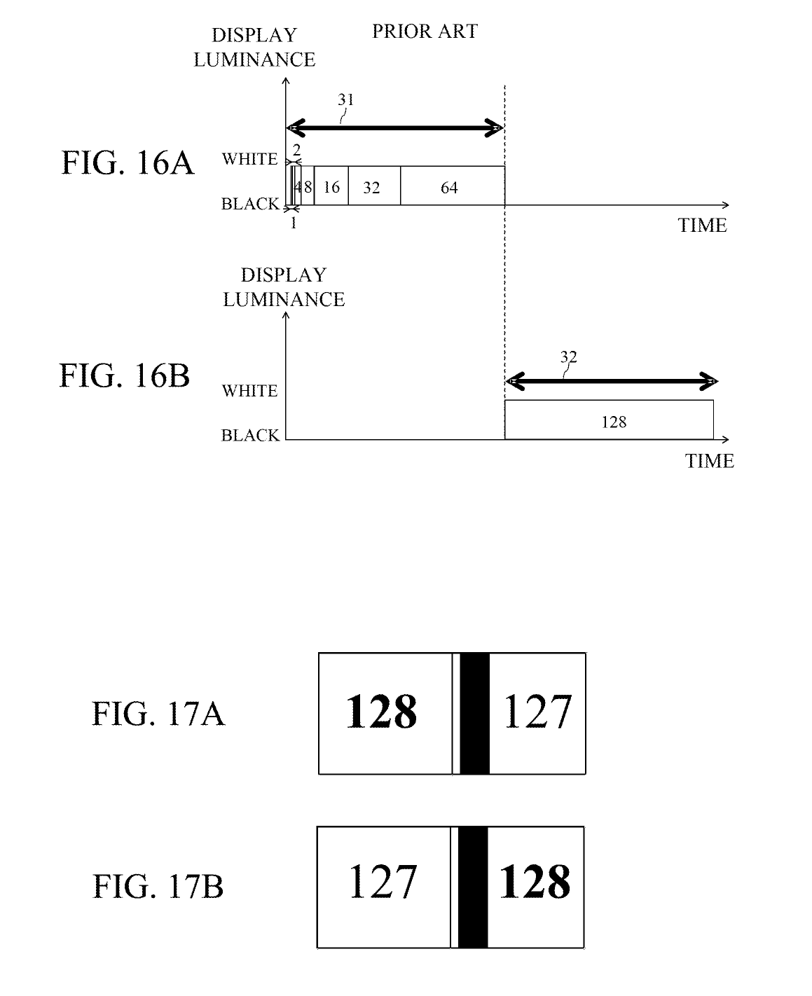

The disclination depends on a factor such as the physical property and temperature of the liquid crystal material. More specifically, the disclination is likely to occur in a standard liquid crystal display element, where the white display (ON) period of the liquid crystal pixel in the state 31 and the black display (OFF) period of the liquid crystal pixel in the state 32 illustrated in FIG. 16 overlap each other for 0.3 msec or longer. The noise filtering process according to this embodiment may be performed where the total time is 0.3 ms or longer of one or two or more subframes in which one of two adjacent pixels is in the ON state and the other is in the OFF state. 0.3 ms may be set to 0.5 ms or 1 ms.

### Second Embodiment

A description will be Liven of a liquid crystal projector according to a second embodiment of the present invention. The configuration of the liquid crystal projector according to this embodiment is the same as that of the first embodiment. However, the noise filtering process performed by the noise filtering block 71 is different from that in the first embodiment.

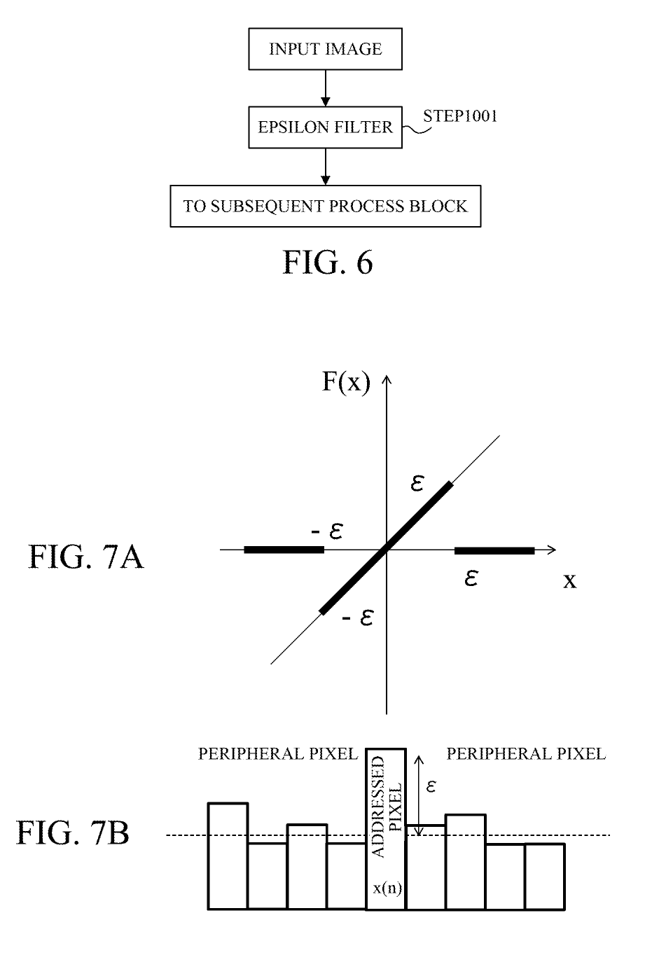

Referring now to a flowchart illustrated in FIG. 6, a description will be given of an epsilon filtering process as a noise filtering process performed by the noise filtering process block 71 according to this embodiment. In the step 1001, the noise filtering process block 71 performs the epsilon filtering process for the input image signal, and outputs the image signal that has received the epsilon filtering process to the other subsequent processing block.

An epsilon filtering process is used as a noise reduction filter of a small amplitude and a high spatial frequency component. The characteristic is calculated by the following equation (1) where x(n) is an input and y(n) is an output.

$$y ( n ) = x ( n ) + {\sum }_{k} {a}_{k} F ( x ( n - k ) - x ( n ) ) \qquad ( 1 )$$

In the expression (1), F(x) is a function indicated by a thick line in FIG. 7A, and “a” is a moving average filter coefficient.

FIG. 7B illustrates an illustrative epsilon filtering process according to this embodiment. In the epsilon filtering process, a tonal difference is calculated between a tone x(n) of an addressed pixel and tones of a surrounding pixel (herein ±4 pixels). Where the tone x(n) of the addressed pixel corresponds to a protrusion or a recess of a small amplitude causing a tonal difference of ε or smaller from the tone of the surrounding pixel, F(x) is set to x. In this case, the epsilon filtering process performs a simply weighted moving average process. On the other hand, where the tone x(n) of the addressed pixel corresponds to a protrusion or a recess of a large amplitude causing a tonal difference larger than ε from the tone of the surrounding pixel, F(x) is always set to 0 and thus no moving average process is performed. This embodiment can provide the same noise filtering process as in the first embodiment, for example, by setting ε to 4.

### Third Embodiment

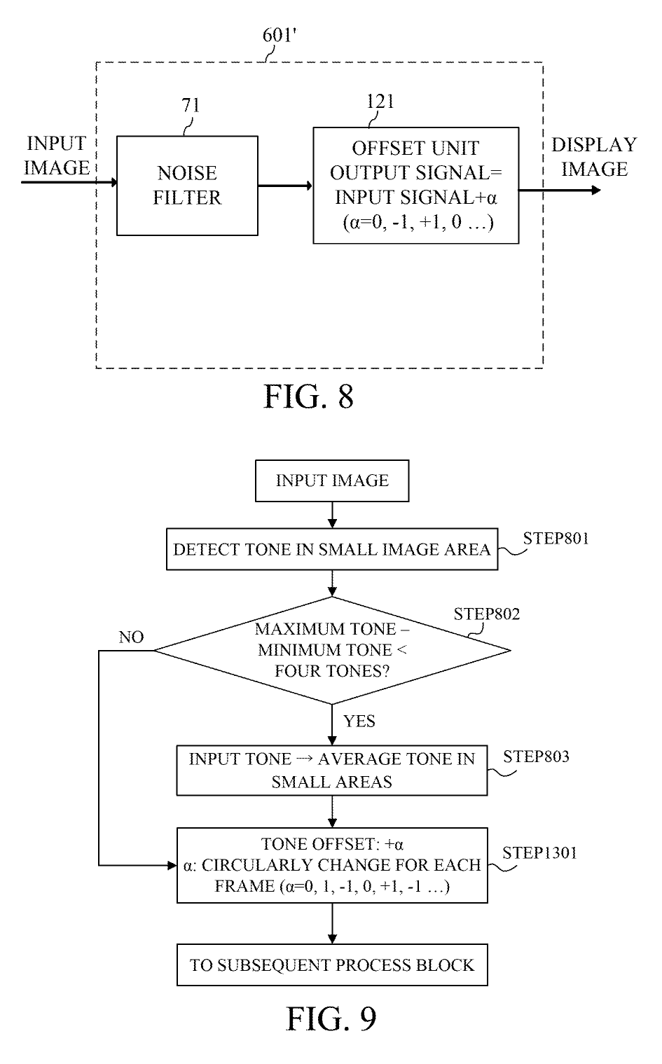

A description will be given of a liquid crystal projector according to a third embodiment of the present invention. The configuration of the liquid crystal projector according to this embodiment is the same as that of the first embodiment except for an image processor 601′ illustrated in FIG. 8. The image processor 60 has an offset unit 121 followed by the noise filtering process block 71 described in the first embodiment.

Referring now to a flowchart of FIG. 9, a description will be given of processes performed by the noise filtering process block 71 and the offset unit 121 in this embodiment will be described. The noise filtering process from the step 801 to the step 803 performed by the noise filtering process block 71 is the same as those in the first embodiment.

In the step 1301 next to the step 803, the offset unit 121 performs a tone offsetting process that adds or subtracts a small offset tone amount to or from each tone in the image signal (all images) after the noise filtering process. The offset tone amount a is a small amount that does not affect the image and is variable for each frame. For example, α=−1, 0, and +1 are circularly changed for each frame.

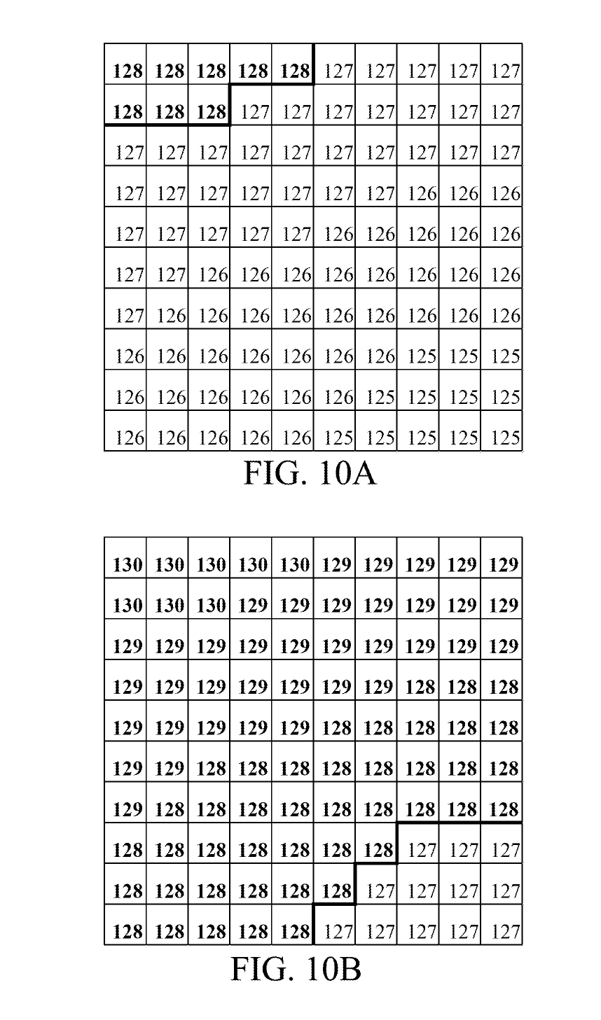

A description will be given of the effect of this tone offsetting process. FIGS. 10A and 10B illustrate a result of adding a tone offset amount with α=+1 and α=−1 to an image area smoothed by the noise filtering process illustrated in FIG. 5B, respectively. As described in the first embodiment, the noise filtering process provides smoothing so that the liquid crystal pixel having the 127th tone and the liquid crystal pixel having the 128th tone are adjacent to each other on a line.

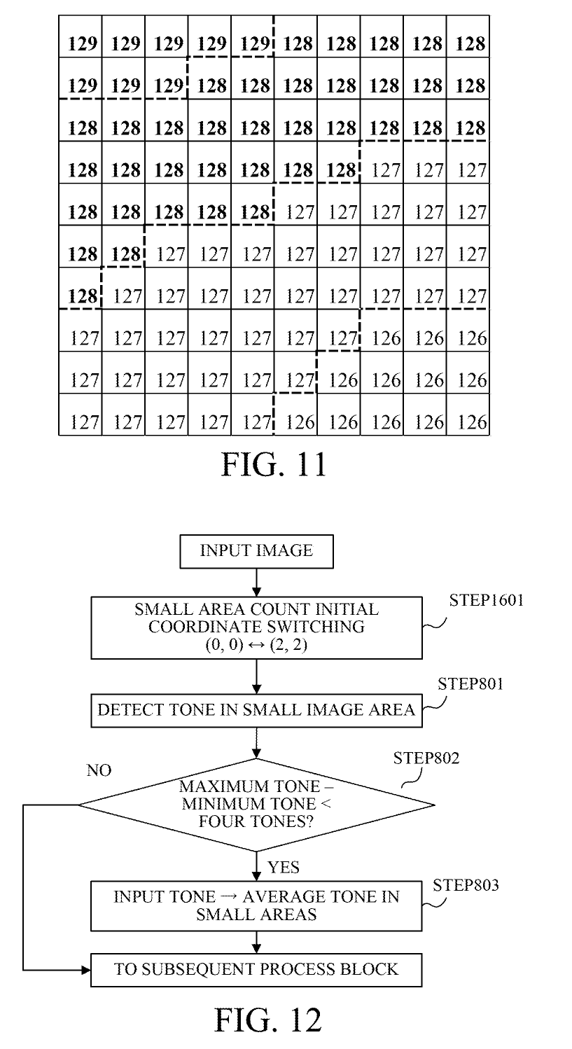

Thereafter, the line or the pseudo contour caused by the disclination shifts in the vertical direction for each frame by adding a tone offset amount (α=+1 0, −1) that is different for each frame. Thereby, the pseudo contours diffuse in the image area in the consecutive frames and are less conspicuous. More specifically, since each of three pseudo contours indicated by dotted lines in FIG. 11 is displayed only for a period that is one-third as long as that of the pseudo contour displayed according to the first embodiment, the concentration of each pseudo contour is also reduced by ⅓. Thus, in comparison with the first embodiment, the pseudo contour is less conspicuous, and the image quality caused by the disclination can be suppressed from deteriorating.

### Fourth Embodiment

A description will be given of a liquid crystal projector according to a fourth embodiment of the present invention. The configuration of the liquid crystal projector according to this embodiment is the same as that of the first embodiment. However, the noise filtering process performed by the noise filtering block 71 is different from that of the first embodiment.

Referring now to a flowchart illustrated in FIG. 12, a description will be given of the noise filtering process performed by the noise filtering process block 71 according to this embodiment.

In the step 1601, the noise filtering process block 71 divides an 8-bit image expressed by the input image signal into a plurality of small image areas which are rectangular areas of vertical 4 pixels×horizontal 4 pixels. The noise filtering process block 71 switches an initial coordinate used to count the small image area of 4×4 pixels to a coordinate at an end of the input image for each frame and a coordinate made by shifting the end by the half of the size of the small image area (2 pixels in this embodiment) in the vertical direction and the horizontal direction. In other words, the position of the small image area is switched for each frame image. The subsequent noise filtering processing in the steps 801 to 803 is the same as that in the first embodiment.

A description will be given of the effect of switching the initial coordinate with which counting the small image area starts for each frame. FIG. 13A illustrates the noise filtering process result when the initial coordinate is set to (2, 2). FIG. 13B illustrates the noise filtering process result when the initial coordinate is set to (0, 0). Shifting the initial coordinate by half of the size of the small image area can shift the coordinate of the liquid crystal pixel where the disclination occurs (referred to as a disclination coordinate hereinafter) by two pixels in both of the vertical and horizontal directions.

Thereby, the image illustrated in FIG. 5B and the image illustrated in FIG. 13B are alternately displayed as the projection image. In the projection image visually recognized as the average of them by the observer, the disclination coordinate diffuses in the consecutive frames, and the concentration of the pseudo contours are reduced and less conspicuous.

The epsilon filtering process described in the second embodiment may be used as that for the third and fourth embodiments.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-186022, filed on Sep. 27, 2017, which is hereby incorporated by reference herein in its entirety.

What is claimed is:

1. A liquid crystal driving apparatus configured to drive a liquid crystal display element, the liquid crystal driving apparatus comprising:
a processor configured to generate a display image signal from an input image signal; and
a driver configured to display, according to the display image signal, a tone to a pixel in the liquid crystal display element by controlling a voltage applied to the pixel in each of a plurality of subframe periods contained in one frame period between a first voltage and a second voltage lower than the first voltage,
wherein the processor performs a smoothing process for smoothing a tonal difference equal to or smaller than 3% of a full scale value of the tone in a target image area in the input image signal.

2. The liquid crystal driving apparatus according to claim 1, wherein the smoothing process replaces tones of all pixels in the target image area with an average tone in the target image area when a difference between a maximum tone and a minimum tone is equal to or smaller than 3% of the full scale value in the target image area.

3. The liquid crystal driving apparatus according to claim 1, wherein the smoothing process smooths the tonal difference equal to or smaller than 2% of the fill scale value.

4. The liquid crystal driving apparatus according to claim 1, wherein the processor performs the smoothing process when a total time is equal to 0.3 ms or longer of one or more subframes in which the first voltage is applied to one of two adjacent pixels in the target image area and the second voltage is applied to the other.

5. The liquid crystal driving apparatus according to claim 1, wherein the processor provides the smoothing process for the target image area and gives a tone offset amount that is variable for each frame period.

6. The liquid crystal driving apparatus according to claim 1, wherein the processor provides the smoothing process for the target image area and changes a position of the target image area for each frame period.

7. The liquid crystal driving apparatus according to claim 1, wherein the processor divides an image based on the input image signal into a plurality of target image areas.

8. An image display apparatus comprising:
a liquid crystal display element; and
a liquid crystal driving apparatus that includes:
a processor configured to generate a display image signal from an input image signal; and
a driver configured to display, according to the display image signal, a tone to a pixel in the liquid crystal display element by controlling a voltage applied to the pixel in each of a plurality of subframe periods contained in one frame period between a first voltage and a second voltage lower than the first voltage,
wherein the processor performs a smoothing process for smoothing a tonal difference equal to or smaller than 3% of a full scale value of the tone in a target image area in the input image signal.

9. A storage medium for storing a computer program that enables a computer to execute an image signal generating process configured to generate a display image signal from an input image signal, and a process configured to display, according to the display image signal, a tone to a pixel in the liquid crystal display element by controlling a voltage applied to the pixel in each of a plurality of subframe periods contained in one frame period between a first voltage and a second voltage lower than the first voltage,
wherein the image signal generating process enables the computer to perform a smoothing process for smoothing a tonal difference equal to or smaller than 3% of a full scale value of the tone in a target image area in the input image signal.
